(19) United States
(12) Patent Application Publication
(10) Pub. No.: US 2026/0341820 A1
(43) Pub. Date: Oct. 29, 2026

(54) BATTERY WIRING MODULE

(71) Applicant: SUMITOMO WIRING SYSTEMS, LTD., Mie (JP)

(72) Inventor: Hiroshi SATO, Mie (JP)

(21) Appl. No.: 18/995,145

(22) PCT Filed: Jul. 13, 2023
(86) PCT No.: PCT/JP2023/025870

§ 371 Date: Jan. 16, 2025

(30) Foreign Application Priority Data
Aug. 1, 2022 (JP) 2022-122699

(51) Int. Cl. H01M 10/48; B60L 50/64; H01M 50/502

(52) U.S. Cl. CPC H01M 10/486; H01M 50/502; B60L 50/64; H01M 2220/20

(57) ABSTRACT

A case (22) of a battery wiring module has a sensor housing part (30) for housing a temperature sensor (60) for detecting the temperature of a battery, a first locking part (41), and a second locking part (51). The first locking part (41) is locked to a first locked part (71) provided on the battery. The second locking part (51) is locked to a second locked part (81) provided on the battery.

### DESCRIPTION

### Technical Field

The present disclosure relates to a battery wiring module.

### Background

As disclosed in Patent Document 1, for example, a battery wiring module is attached to a high-voltage battery that is mounted as a travelling power source in vehicles such as electric vehicles and hybrid vehicles. The battery wiring module includes electric wires that are electrically connected to the battery, and a case for housing the electric wires. The case also houses a temperature sensor for detecting the temperature of the battery. The temperature sensor is pressed against the battery by a biasing part, such as a spring. This realizes highly accurate detection of the battery temperature.

### PRIOR ART DOCUMENT

### Patent Document

Patent Document 1: JP 2014-089912 A

### SUMMARY OF THE INVENTION

### Problems to Be Solved

When the force exerted by the biasing part pressing against the temperature sensor with the battery wiring module in a state attached to the battery is referred to as a pressing force, there is a concern that the case will be separated from the battery, that is, rise due to the reaction force to that pressing force.

The present disclosure aims to provide a battery wiring module capable of suppressing the rising of the case.

### Means to Solve the Problem

The battery wiring module of the present disclosure is a battery wiring module that is attachable to a battery, and includes: an electric wire to be electrically connected to the battery; and a case housing the electric wire, wherein the case has: a sensor housing part for housing a temperature sensor for detecting a temperature of the battery; and a locking part to be locked to a locked part provided on the battery.

### Effect of the Invention

The battery wiring module of the present disclosure exhibits the effect of suppressing the rising of the case.

### BRIEF DESCRIPTION OF THE DRAWINGS

FIG. 1 is a schematic plan view of a battery wiring module of an embodiment.

FIG. 2 is a perspective view of a portion of a case of the battery wiring module of the same embodiment.

FIG. 3 is a plan view of a portion of the case of the battery wiring module of the same embodiment.

FIG. 4 is a 4-4 cross-sectional view of FIG. 3.

### DETAILED DESCRIPTION TO EXECUTE THE INVENTION

### Description of Embodiments of Present Disclosure

Firstly, modes for carrying out the present disclosure are listed and described.

[1] The battery wiring module of the present disclosure is a battery wiring module that is attachable to a battery, and includes: an electric wire to be electrically connected to the battery; and a case housing the electric wire, wherein the case has: a sensor housing part for housing a temperature sensor for detecting a temperature of the battery; and a locking part to be locked to a locked part provided on the battery.

According to this configuration, the locking part that is locked to the locked part of the battery can hold the case such that the case is not separated from the battery. This can suppress the rising of the case.

[2] In the above item [1], a plurality of the locking parts may be provided, and a plurality of the locked parts may be provided in correspondence with the respective locking parts.

[3] In the above item [2], the plurality of locking parts may include a first locking part and a second locking part, the plurality of locked parts may include: a first locked part to which the first locking part is to be locked; and a second locked part to which the second locking part is to be locked, and the sensor housing part may be located between the first locking part and the second locking part.

According to this configuration, the first and second locking parts can hold the case on the respective sides of the sensor housing part such that the case is not separated from the battery. This can more preferably suppress the rising of a region of the case including the sensor housing part.

[4] In the above item [3], the battery may include a plurality of battery cells arranged along one direction, and the sensor housing part, the first locking part, and the second locking part may be arranged in the direction in which the plurality of battery cells are arranged.

According to this configuration, the first and second locking parts can be located on the respective sides of the sensor housing part in the direction in which the battery cells are arranged. As a result, the first and second locking parts can preferably suppress the rising of the case.

[5] In the above item [4], the case may have a plurality of busbar holders for holding a busbar forming a conductive path together with the electric wire, the plurality of busbar holders may be arranged along the direction in which the plurality of battery cells are arranged, the sensor housing part may span between two busbar holders adjacent to each other, of the plurality of busbar holders, and the first locking part and the second locking part may be provided in respective busbar holders that are included in the plurality of busbar holders, different from the two busbar holders between which the sensor housing part spans, and located next to the two busbar holders.

According to this configuration, the first and second locking parts can be located at positions closer to the sensor housing part on the respective sides thereof. As a result, the first and second locking parts can preferably suppress the rising of the case.

### Details of Embodiments of the Present Disclosure

Specific examples of the battery wiring module of the present disclosure are described below with reference to the drawings. The drawings may partially exaggerate or simplify configurations for convenience of description. The dimensional ratio of each part may differ between the drawings. Note that the term “opposing/facing” as used herein means that surfaces or members are at positions directly facing each other, and includes not only the case of being at positions entirely facing each other but also the case of being at positions partially facing each other. Further, the term “opposing/facing” as used herein includes both the case where another member is interposed between two portions and the case where nothing is interposed between two portions.

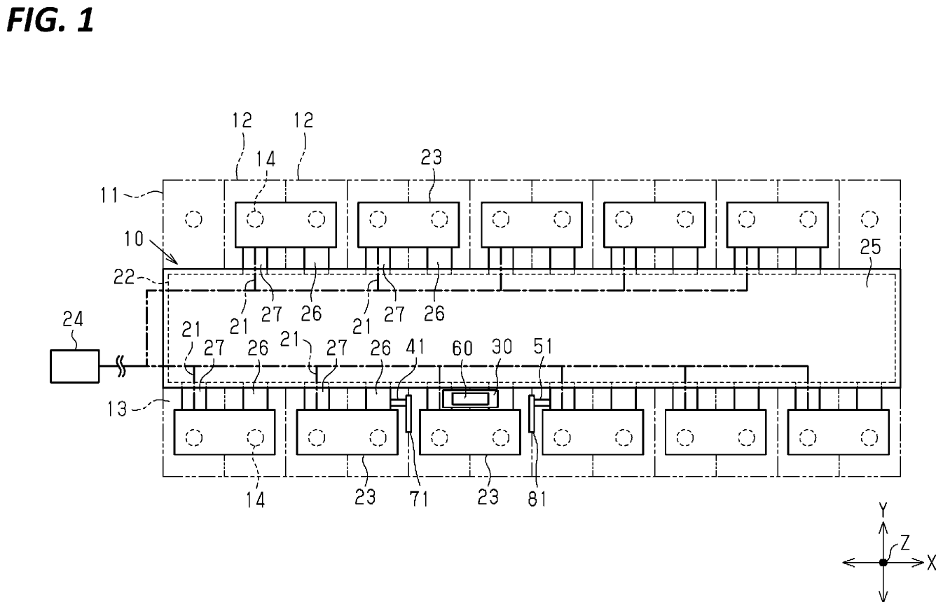

As shown in FIG. 1, a battery wiring module 10 of the present embodiment is configured, for example, to be attached to a battery 11 mounted in an electric vehicle, a hybrid vehicle, or the like. The battery 11 is, for example, a secondary battery. The battery 11 supplies electric power to a travel motor of a vehicle (not shown). Further, the battery 11 receives the supply of electric power from the travel motor and a power-generating motor in accordance with the state of charge and the driving state of the vehicle.

The battery 11 includes a plurality of battery cells 12. The battery 11 has, for example, a substantially rectangular-parallelepiped shape with the plurality of battery cells 12 arranged in rows in one direction. In the following description, the “X-direction” refers to the direction in which the battery cells 12 are arranged, and the “Y-direction” refers to the direction perpendicular to the X-direction. The “Z-direction”, which is orthogonal to the X-direction and the Y-direction, refers to the up-down direction. The term “above/upward/upper side” refers to the side from which the battery wiring module 10 is attached to the battery 11. That is, the battery 11 has a module attachment surface 13, which is an upper surface to which the battery wiring module 10 is attached.

Each battery cell 12 has two battery terminals 14. One of the two battery terminals 14 is a positive terminal, and the other one is a negative terminal. When the battery cells 12 are arranged in the X-direction, the two battery terminals 14 are arranged along the Y-direction on the upper surface of the battery cells 12.

### (Configuration of Battery Wiring Module 10)

The battery wiring module 10 includes a plurality of electric wires 21 that are electrically connected to the battery 11, and a case 22 for housing the electric wires 21. The battery wiring module 10 also includes a plurality of busbars 23, which are supported by the case 22, for example. The busbars 23 are located on both sides in the Y-direction of the case 22, and are arranged side by side along the X-direction. Each busbar 23 connects battery terminals 14 that are adjacent to each other in the X-direction. The busbars 23 are connected to the battery terminals 14 by welding, for example. Each busbar 23 is electrically connected to a corresponding electric wire 21. The busbars 23 form conductive paths together with the electric wires 21. Each electric wire 21 is, for example, a detection wire for detecting the voltage of the corresponding busbar 23. Each electric wire 21 is connected to a connector 24 for connecting to a detection device (not shown). The battery wiring module 10 also includes a cover 25 that covers the upper side of the case 22.

### (Configuration of Case 22)

The case 22 is made of an insulating material, such as synthetic resin. The case 22 has first busbar holders 26 and second busbar holders 27. The first busbar holders 26 have a shape different from the second busbar holders 27. A plurality of first busbar holders 26 and a plurality of second busbar holders 27 are arranged alternately in the X-direction. The first busbar holders 26 and the second busbar holders 27 form two rows in correspondence with two rows of the busbars 23 that are arranged in the X-direction. A pair of a first busbar holder 26 and a second busbar holder 27 that are adjacent to each other in the X-direction hold one busbar 23. Each busbar 23 spans between the first busbar holder 26 and the second busbar holder 27 that are adjacent to each other in the X-direction.

The case 22 has sensor housing parts 30. The sensor housing part 30 houses a temperature sensor 60 for detecting the temperature of the battery 11.

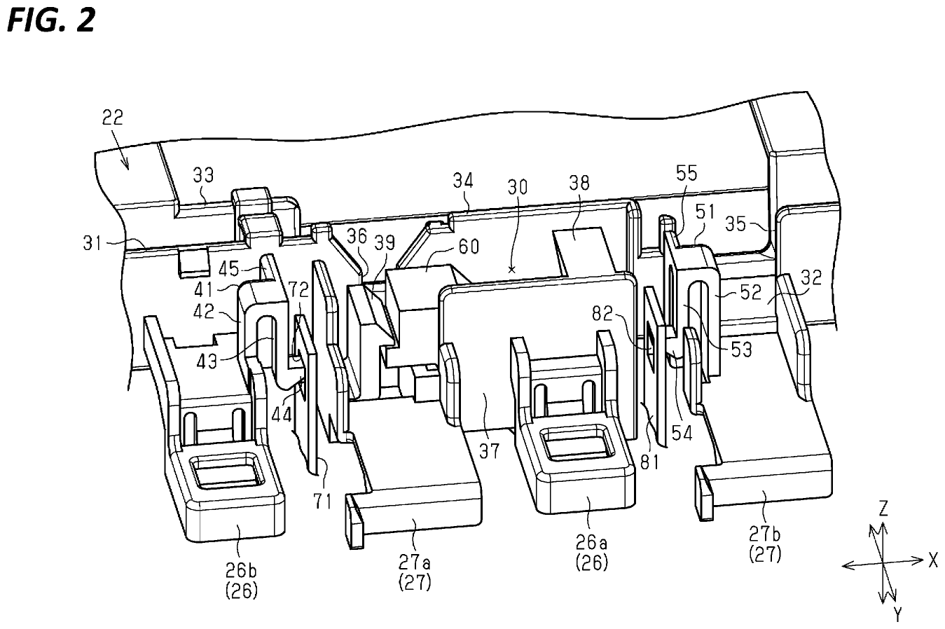

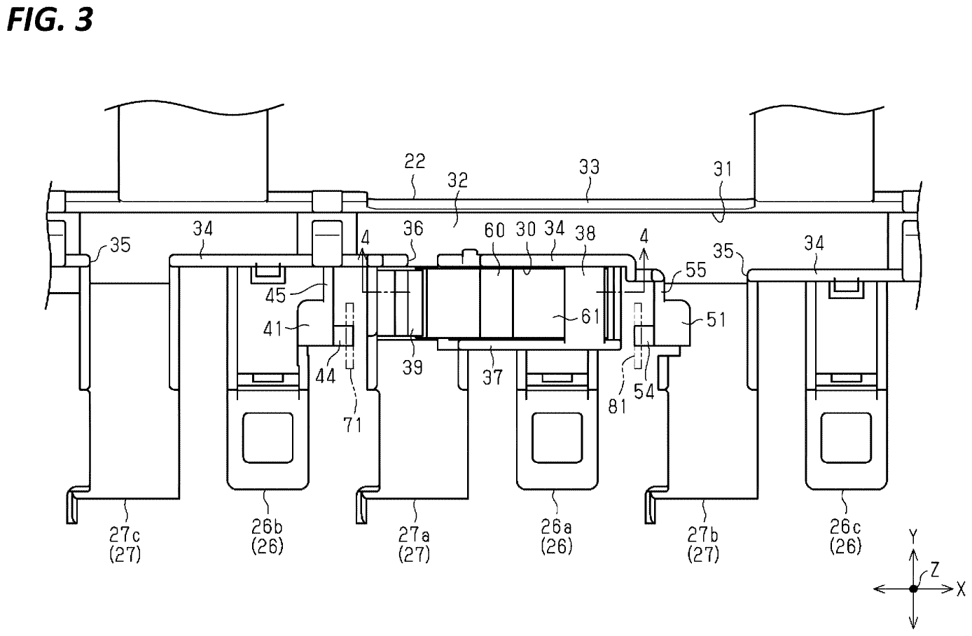

FIGS. 2 and 3 show a region around the sensor housing part 30 in the case 22. The case 22 has a wire housing part 31, which extends in the X-direction. The wire housing part 31 has a bottom wall 32, and a pair of side walls 33 and 34 that face each other in the Y-direction. The lower face of the bottom wall 32 faces the aforementioned module attachment surface 13 in the Z-direction. The side walls 33 and 34 extend upward from the bottom wall 32. The electric wire 21 is housed in a space between the side walls 33 and 34 that are spaced apart in the Y-direction. Note that, of the two side walls 33 and 34, the side wall 33 is a side wall located inward in the Y-direction, and the side wall 34 is a side wall located outward in the Y-direction. The first busbar holders 26 and the second busbar holders 27 are located outward in the Y-direction of the wire housing part 31. Note that the upper side of the wire housing part 31, which is open, is covered by the cover 25.

The sensor housing part 30 spans between one first busbar holder 26 and one second busbar holder 27 that are adjacent to each other in the X-direction. In the following description, the first busbar holder 26 and the second busbar holder 27 on which the sensor housing part 30 is formed are referred to as a first busbar holder 26a and a second busbar holder 27a, respectively. A first busbar holder 26b refers to a first busbar holder 26 that is adjacent to the second busbar holder 27a in the X-direction and located on the opposite side to the first busbar holder 26a. A second busbar holder 27b refers to a second busbar holder 27 that is adjacent to the first busbar holder 26a in the X-direction and located on the opposite side to the second busbar holder 27a. As shown in FIG. 3, first busbar holders 26c refer to the first busbar holders 26 other than the first busbar holders 26a and 26b. Second busbar holders 27c refer to the second busbar holders 27 other than the second busbar holders 27a and 27b.

As shown in FIG. 3, the first busbar holders 26b and 26c and the second busbar holders 27b and 27c extend outward in the Y-direction from the wire housing part 31. The first busbar holder 26a and the second busbar holder 27a extend outward in the Y-direction from the sensor housing part 30. The side wall 34 of the wire housing part 31 has first openings 35 at positions corresponding to the second busbar holders 27b and 27c. The side wall 34 of the wire housing part 31 also has a second opening 36 at a position corresponding to the second busbar holder 27a. Each electric wire 21 is pulled from inside the wire housing part 31 to the outside in the Y-direction through the first opening 35 or the second opening 36.

### (Configuration of Sensor Housing Part 30)

As shown in FIGS. 2 and 3, the case 22 has an opposing wall 37 that spans between the first busbar holder 26a and the second busbar holder 27a. The opposing wall 37 is located outward in the Y-direction of the side wall 34 of the wire housing part 31. The opposing wall 37 is, for example, parallel with the side wall 34. The opposing wall 37 faces the side wall 34 in the Y-direction. The first busbar holder 26a extends outward in the Y-direction from the opposing wall 37.

The sensor housing part 30 is located between the side wall 34 and the opposing wall 37. Further, the sensor housing part 30 is located between the first busbar holder 26a and the wire housing part 31. The sensor housing part 30 has a spring support 38. The spring support 38 connects the side wall 34 and the opposing wall 37.

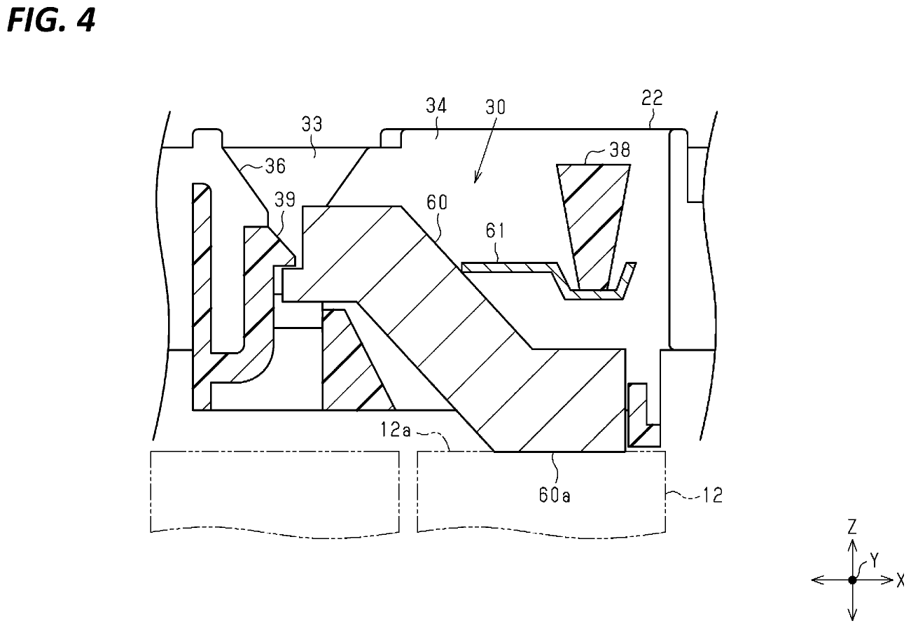

As shown in FIG. 4, the sensor housing part 30 houses the temperature sensor 60 and a spring member 61. The spring member 61 is located between the temperature sensor 60 and the spring support 38. The spring member 61 biases the temperature sensor 60 downward. The temperature sensor 60 is, for example, a thermistor. The temperature sensor 60 has a temperature detection surface 60a. The biasing force of the spring member 61 presses the temperature detection surface 60a of the temperature sensor 60 against an upper surface 12a of a battery cell 12. The case 22 also has a holding claw 39 for holding the temperature sensor 60. As shown in FIG. 2, the holding claw 39 is located at a base end of the second busbar holder 27a.

### (Configuration of First Locking Part 41 and Second Locking Part 51)

As shown in FIG. 2, the case 22 has a first locking part 41 and a second locking part 51 on respective sides in the X-direction of the sensor housing part 30.

The first locking part 41 is located at a base end of the first busbar holder 26b. The first locking part 41 has, for example, a first extension 42, a second extension 43, and a claw 44. The first extension 42 extends upward in the Z-direction from the first busbar holder 26b. The second extension 43 is bent back into a substantially U-shape from the upper end of the first extension 42 and extends downward in the Z-direction. The first locking part 41 is bendable in the X-direction due to the substantially U-shape formed by the first extension 42 and the second extension 43. Further, the case 22 has a joint wall 45 that connects the first locking part 41 and the side wall 34.

The claw 44 protrudes in the X-direction from the lower end of the second extension 43, for example. The claw 44 is locked to a first locked part 71 provided on the battery 11. The first locked part 71 is a portion of the battery 11 that extends upward from the battery 11. For example, the claw 44 is inserted into a locking hole 72 provided in the first locked part 71. The claw 44 is then caught on the upper side in the Z-direction of the locking hole 72. The first locking part 41 thus holds the case 22 such that the case 22 is not separated from the battery 11 in the Z-direction.

The second locking part 51 is located at a base end of the second busbar holder 27b. The second locking part 51 has, for example, a first extension 52, a second extension 53, and a claw 54. The first extension 52 extends upward in the Z-direction from the second busbar holder 27b. The second extension 53 is bent back into a substantially U-shape from the upper end of the first extension 52 and extends downward from the Z-direction. The second locking part 51 is bendable in the X-direction due to the substantially U-shape formed by the first extension 52 and the second extension 53. Further, the case 22 has a joint wall 55 that connects the second locking part 51 and the side wall 34.

The claw 54 protrudes in the X-direction from the lower end of the second extension 53, for example. The claw 54 is locked to a second locked part 81 provided on the battery 11. The second locked part 81 is a portion of the battery 11 that extends upward from the battery 11. For example, the claw 54 is inserted into a locking hole 82 provided in the second locked part 81. The claw 54 is then caught on the upper side in the Z-direction of the locking hole 82. The second locking part 51 thus holds the case 22 such that the case 22 is not separated from the battery 11 in the Z-direction.

Next, operation of the present embodiment will be described.

When the case 22 is in a state attached to the battery 11, the spring support 38 of the sensor housing part 30 receives a force in a direction pushing the spring support 38 upward from the spring member 61, which applies a biasing force to the temperature sensor 60. Here, the first locking part 41 and the second locking part 51 located on the respective sides in the X-direction of the sensor housing part 30 are locked to the first locked part 71 and the second locked part 81, respectively. That is, the force of the spring member 61 pushing up the spring support 38 can be received by the first locking part 41 and the second locking part 51. Therefore, the force of the spring member 61 can suppress the rising of the sensor housing part 30 from the battery 11.

Effects of the present embodiment will be described.
(1) The case 22 has a first locking part 41 and a second locking part 51, which are respectively locked to the first locked part 71 and the second locked part 81 provided on the battery 11. According to this configuration, the first locking part 41 and the second locking part 51 can hold the case 22 such that the case 22 is not separated from the battery 11. This can suppress the rising of the case 22.
(2) The case 22 has a plurality of locking parts, namely a first locking part 41 and a second locking part 51. According to this configuration, the first locking part 41 and the second locking part 51 can firmly hold the case 22 such that the case 22 is not separated from the battery 11.
(3) The sensor housing part 30 is located between the first locking part 41 and the second locking part 51 in the X-direction. According to this configuration, the first locking part 41 and the second locking part 51 can hold the case 22 on the respective sides of the sensor housing part 30 such that the case 22 is not separated from the battery 11. This allows the first locking part 41 and the second locking part 51 to preferably receive the reaction force of the force pressing the temperature sensor 60 against the battery 11. This can more preferably suppress the rising of a region of the case 22 including the sensor housing part 30.
(4) The battery 11 includes a plurality of battery cells 12 that are arranged along the X-direction. The sensor housing part 30, the first locking part 41, and the second locking part 51 are arranged in the direction in which the plurality of battery cells 12 are arranged. According to this configuration, the first locking part 41 and the second locking part 51 can be provided on the respective sides of the sensor housing part 30 in the direction in which the battery cells 12 are arranged. As a result, the first locking part 41 and the second locking part 51 can preferably suppress the rising of the case 22.
(5) The case 22 has a plurality of first busbar holders 26 and second busbar holders 27 that hold busbars 23, which form conductive paths together with the electric wires 21. The plurality of first busbar holders 26 and second busbar holders 27 are arranged in the direction in which the plurality of battery cells 12 are arranged, i.e., the X-direction. The sensor housing part 30 spans between the first busbar holder 26a and the second busbar holder 27a that are adjacent to each other in the X-direction. The first locking part 41 and the second locking part 51 are located respectively on the first busbar holder 26b and the second busbar holder 27b that are adjacent respectively to the first busbar holder 26a and the second busbar holder 27a between which the sensor housing part 30 spans. According to this configuration, the first locking part 41 and the second locking part 51 can be provided at positions closer to the sensor housing part 30 on the respective sides thereof. As a result, the first locking part 41 and the second locking part 51 can preferably suppress the rising of the case 22.

### (Modifications)

The present embodiment can be modified as follows when implemented. The present embodiment and the following modifications can be implemented in combination as long as no technical contradiction arises.
The protrusion/recess relationship in the locking structure between the first locking part 41 and the first locked part 71 may be inverted from the relationship in the above embodiment. That is, it is possible to provide the first locked part 71 with a protrusion and provide the first locking part 41 with a recess into which that protrusion is inserted. Similarly, it is possible to provide the second locked part 81 with a protrusion and provide the second locking part 51 with a recess into which that protrusion is inserted.
In the above embodiment, the first locking part 41 and the second locking part 51 are located on the respective sides in the X-direction of the sensor housing part 30. In addition to this, for example, the first locking part 41 and the second locking part 51 may also be located on the respective sides in the Y-direction of the sensor housing part 30.
In the above embodiment, either the first locking part 41 or the second locking part 51 may be omitted. That is, the number of locking parts of the case 22 that are locked to locked parts of the battery 11 may alternatively be one.
The sensor housing part 30 of the above embodiment spans between the first busbar holder 26a and the second busbar holder 27a, but the position at which the sensor housing part 30 is disposed in the case 22 is not specifically limited to the above embodiment.
The embodiment and the modifications disclosed herein are illustrative in all respects, and should not be considered restrictive. That is, the scope of the present invention is defined by the claims, and is intended to encompass all modifications within the meaning and scope equivalent to the claims.

### LIST OF REFERENCE NUMERALS

10 Battery wiring module
11 Battery
12 Battery cell
12a Upper surface
13 Module attachment surface
14 Battery terminal
21 Electric wire
22 Case
23 Busbar
24 Connector
25 Cover
26 (26a, 26b, 26c) First busbar holder (busbar holder)
27 (27a, 27b, 27c) Second busbar holder (busbar holder)
30 Sensor housing part
31 Wire housing part
32 Bottom wall
33, 34 Side wall
35 First opening
36 Second opening
37 Opposing wall
38 Spring support
39 Holding claw
41 First locking part (locking part)
42 First extension
43 Second extension
44 Claw
45 Joint wall
51 Second locking part (locking part)
52 First extension
53 Second extension
54 Claw
55 Joint wall
60 Temperature sensor
60a Temperature detection surface
61 Spring member
71 First locked part (locked part)
72 Locking hole
81 Second locked part (locked part)
82 Locking hole

1. A battery wiring module that is attachable to a battery, the battery wiring module comprising:
an electric wire to be electrically connected to the battery; and
a case housing the electric wire,
wherein the case has: a sensor housing part for housing a temperature sensor for detecting a temperature of the battery; and a locking part to be locked to a locked part provided on the battery.

2. The battery wiring module according to claim 1,
wherein a plurality of the locking parts are provided, and
a plurality of the locked parts are provided in correspondence with the respective locking parts.

3. The battery wiring module according to claim 2,
wherein the plurality of locking parts include a first locking part and a second locking part,
the plurality of locked parts include: a first locked part to which the first locking part is to be locked; and a second locked part to which the second locking part is to be locked, and
the sensor housing part is located between the first locking part and the second locking part.

4. The battery wiring module according to claim 3,
wherein the battery includes a plurality of battery cells arranged along one direction, and
the sensor housing part, the first locking part, and the second locking part are arranged in the direction in which the plurality of battery cells are arranged.

5. The battery wiring module according to claim 4,
wherein the case has a plurality of busbar holders for holding a busbar forming a conductive path together with the electric wire,
the plurality of busbar holders are arranged along the direction in which the plurality of battery cells are arranged,
the sensor housing part spans between two busbar holders adjacent to each other, of the plurality of busbar holders, and
the first locking part and the second locking part are provided in respective busbar holders that are included in the plurality of busbar holders, different from the two busbar holders between which the sensor housing part spans, and located next to the two busbar holders.
